(19) United States
(12) Patent Application Publication
(10) Pub. No.: US 2025/0299681 A1
(43) Pub. Date: Sep. 25, 2025

(54) ENCODER COMPRISING AN INTER-CHANNEL PHASE DIFFERENCE CALCULATOR DEVICE AND METHOD FOR OPERATING SUCH ENCODER

(71) Applicant: FRAUNHOFER-GESELLSCHAFT ZUR FÖRDERUNG DER ANGEWANDTEN FORSCHUNG E.V., München (DE)

(72) Inventors: Franz REUTELHUBER, Erlangen (DE); Eleni FOTOPOULOU, Erlangen (DE); Jan Frederik KIENE, Erlangen (DE); Stefan DÖHLA, Erlangen (DE); Kacper SAGNOWSKI, Erlangen (DE); Markus MULTRUS, Erlangen (DE)

(21) Appl. No.: 19/229,887

(22) Filed: Jun. 5, 2025

Related U.S. Application Data
(63) Continuation of application No. PCT/EP2023/083994, filed on Dec. 1, 2023.

(30) Foreign Application Priority Data
Dec. 7, 2022 (EP) 22212047.9

(51) Int. Cl. G10L 19/008; H04S 1/00; H04S 7/00

(52) U.S. Cl. CPC G10L 19/008; H04S 1/007; H04S 7/00; H04S 2400/03

(57) ABSTRACT

The invention provides an encoder for producing an audio bitstream from a stereo audio signal. The encoder comprises:
a downmixer configured for downmixing the stereo audio signal in order to produce a mono audio signal;
an inter-channel phase difference calculator device configured for calculating an inter-channel phase difference for each time segment of a plurality of consecutive time segments of the stereo audio signal; and
a bitstream producer configured to produce the audio bitstream in such way that the mono audio signal and the inter-channel phase differences for the plurality of consecutive time segments are embedded in the audio bitstream;
wherein the inter-channel phase difference calculator device comprises an inter-channel phase difference calculator being configured for calculating the inter-channel phase difference depending on a global inter-channel phase difference of a current time segment and depending on a mean bandwise inter-channel phase difference change of the current time segment.

### CROSS-REFERENCE TO RELATED APPLICATIONS

This application is a continuation of copending International Application No. PCT/EP2023/083994, filed Dec. 1, 2023, which is incorporated herein by reference in its entirety, and additionally claims priority from European Application No 22212047.9, filed Dec. 7, 2022, which is also incorporated herein by reference in its entirety.

### BACKGROUND OF THE INVENTION

Inter-channel phase differences (IPDs) describe how aligned two channels are in terms of the phase of their respective signals. Inter-channel phase differences range from 0 (completely phase-aligned) to +/−π (completely out-of-phase). The more out-of-phase the two channels are, the more problems this can bring when creating a single downmix channel from them as such phase shifts can lead to severe cancellation effects significantly reducing the energy in the downmix. It is therefore advisable to estimate and compensate the inter-channel phase differences for strongly out-of-phase signals in order to avoid these effects. In an audio coder that uses a parametric stereo approach, i.e. transmitting only one downmix and side information used for upmixing the downmix back to a stereo representation, inter-channel phase differences would typically be part of the side information. They are estimated at the encoder (either broadband or in multiple smaller frequency bands) and then compensated to align the channels for better downmixing. At the decoder, they are finally re-applied again as part of the upmix to restore the original phase shift between the channels.

However, for inter-channel phase difference compensation to have a positive effect on the eventual audio quality, the stability of the used inter-channel phase differences plays an important role. If the inter-channel phase differences fluctuate a lot over time, this will most likely also lead to audible spatial fluctuations in the output, which will be negatively perceived by listeners.

Stereo coding relying on a single downmix channel and a parametric representation of the spatial cues is a well-known method for efficient audio data compression of stereo signals. It has been used in several established technologies, such as Binaural Cue Coding [1] [2] or Parametric Stereo Coding [3] [4].

For some types of signals, e.g. stereo speech signals recorded with an mid-side microphone setup, it could be shown that using only inter-channel loudness differences (ILDs) and inter-channel coherence (IC) as stereo parameters is enough to achieve high-quality coding results [5, 6]. However, for other types of input, especially binauralized signals, it has turned out that it is also quite important to consider inter-channel time differences (ITDs) and inter-channel phase differences for efficient coding of such signals [7].

Later on, further techniques were developed to improve the use of inter-channel time differences and inter-channel phase differences in audio codecs, like using whole-band inter-channel time differences/inter-channel phase differences for low-bitrate scenarios [8], switching inter-channel phase difference compensation on and off adaptively [9] or usage in a coder specifically tailored towards conversational speech [10].

For input with strongly frequency-dependent phase differences, e.g. binauralized input, using large bands for estimating the inter-channel phase differences can lead to large variations of the estimate over short time periods depending on the spectral distribution of signal in the given frames, even though the actual phase differences stay more or less constant. This effect can be minimized by estimating the inter-channel phase differences in smaller bands where they tend to be much more stable over time. However, transmitting a larger number of inter-channel phase differences for smaller bands also involves spending more bits on inter-channel phase differences, which will decrease the number of available bits for everything else. Additionally, compensating a large number of different small-band inter-channel phase differences at the same time also bears the risk of introducing instabilities. It is therefore desirable to keep the number of transmitted inter-channel phase differences relatively low while also avoiding strong fluctuations in the inter-channel phase differences for signals that are actually relatively stable over time. In order to achieve this a stabilization mechanism based on a finer phase analysis is needed.

### SUMMARY

According to an embodiment, an encoder for producing an audio bitstream from a stereo audio signal may have:
a downmixer configured for downmixing the stereo audio signal in order to produce a mono audio signal;
an inter-channel phase difference calculator device configured for calculating an inter-channel phase difference for each time segment of a plurality of consecutive time segments of the stereo audio signal; and
a bitstream producer configured to produce the audio bitstream in such way that the mono audio signal and the inter-channel phase differences for the plurality of consecutive time segments are embedded in the audio bitstream;
wherein the inter-channel phase difference calculator device comprises a global inter-channel phase difference calculator configured for calculating a global inter-channel phase difference for each time segment of the plurality of consecutive time segments based on a frequency band of the stereo audio signal;
wherein the frequency band comprises a plurality of subbands, wherein the inter-channel phase difference calculator device comprises a bandwise inter-channel phase difference calculator configured for calculating a bandwise inter-channel phase difference for each of a subset of the subbands for each time segment of the plurality of consecutive time segments;
wherein the inter-channel phase difference calculator device comprises a bandwise inter-channel phase difference change calculator configured for calculating a bandwise inter-channel phase difference change for each of the subset of the subbands for each time segment of the plurality of consecutive time segments based on the bandwise inter-channel phase difference of a current time segment of the plurality of consecutive time segments and the bandwise inter-channel phase difference of at least one previous time segment of the plurality of consecutive time segments of the respective subband;
wherein the inter-channel phase difference calculator device comprises a mean bandwise inter-channel phase difference change calculator configured for calculating a mean bandwise inter-channel phase difference change for each time segment of the plurality of consecutive time segments based on the bandwise inter-channel phase difference changes of each of the subset of the subbands;
wherein the inter-channel phase difference calculator device comprises an inter-channel phase difference calculator configured for calculating the inter-channel phase difference of the current time segment depending on the global inter-channel phase difference of the current time segment and depending on the mean bandwise inter-channel phase difference change of the current time segment.

According to another embodiment, a method for operating an encoder for producing an audio bitstream from a stereo audio signal may have the steps of
using a downmixer of the encoder for downmixing the stereo audio signal in order to produce a mono audio signal;
using an inter-channel phase difference calculator device of the encoder for calculating an inter-channel phase difference for each time segment of a plurality of consecutive time segments of the stereo audio signal;
using a bitstream producer of the encoder to produce the audio bitstream in such way that the mono audio signal and the inter-channel phase differences for the plurality of consecutive time segments are embedded in the audio bitstream;
using a global inter-channel phase difference calculator of the inter-channel phase difference calculator device for calculating a global inter-channel phase difference for each time segment of the plurality of consecutive time segments based on a frequency band of the stereo audio signal, wherein the frequency band comprises a plurality of subbands;
using a bandwise inter-channel phase difference calculator of the inter-channel phase difference calculator device for calculating a bandwise inter-channel phase difference for each of a subset of the subbands for each time segment of the plurality of consecutive time segments;
using a bandwise inter-channel phase difference change calculator of the inter-channel phase difference calculator device for calculating a bandwise inter-channel phase difference change for each of the subset of the subbands for each time segment of the plurality of consecutive time segments based on the bandwise inter-channel phase difference of a current time segment of the plurality of consecutive time segments and the bandwise inter-channel phase difference of at least one previous time segment of the plurality of consecutive time segments of the respective subband;
using a mean bandwise inter-channel phase difference change calculator of the inter-channel phase difference calculator device for calculating a mean bandwise inter-channel phase difference change for each time segment of the plurality of consecutive time segments based on the bandwise inter-channel phase difference changes of each of the subset of the subbands;
using an inter-channel phase difference calculator of the inter-channel phase difference calculator device for calculating the inter-channel phase difference of the current time segment depending on the global inter-channel phase difference of the current time segment and depending on the mean bandwise inter-channel phase difference change of the current time segment.

Another embodiment may have a non-transitory digital storage medium having a computer program stored thereon to perform the inventive method when said computer program is run by a computer.

In a first aspect, the invention provides an encoder for producing an audio bitstream from a stereo audio signal. The encoder comprises:
a downmixer configured for downmixing the stereo audio signal in order to produce a mono audio signal;
an inter-channel phase difference calculator device configured for calculating an inter-channel phase difference for each time segment of a plurality of consecutive time segments of the stereo audio signal; and
a bitstream producer configured to produce the audio bitstream in such way that the mono audio signal and the inter-channel phase differences for the plurality of consecutive time segments are embedded in the audio bitstream;
wherein the inter-channel phase difference calculator device comprises a global inter-channel phase difference calculator configured for calculating a global inter-channel phase difference for each time segment of the plurality of consecutive time segments based on a frequency band of the stereo audio signal;
wherein the frequency band comprises a plurality of subbands, wherein the inter-channel phase difference calculator device comprises a bandwise inter-channel phase difference calculator configured for calculating a bandwise inter-channel phase difference for each of a subset of the subbands for each time segment of the plurality of consecutive time segments;
wherein the inter-channel phase difference calculator device comprises a bandwise inter-channel phase difference change calculator configured for calculating a bandwise inter-channel phase difference change for each of the subset of the subbands for each time segment of the plurality of consecutive time segments based on the bandwise inter-channel phase difference of a current time segment of the plurality of consecutive time segments and the inter-channel phase difference of at least one previous time segment of the plurality of consecutive time segments of the respective subband;
wherein the inter-channel phase difference calculator device comprises a mean bandwise inter-channel phase difference change calculator configured for calculating a mean bandwise inter-channel phase difference change for each time segment of the plurality of consecutive time segments based on the bandwise inter-channel phase difference changes of each of the subset of the subbands;
wherein the inter-channel phase difference calculator device comprises an inter-channel phase difference calculator, wherein the inter-channel phase difference calculator is configured for calculating the inter-channel phase difference depending on the global inter-channel phase difference of the current time segment and depending on the mean bandwise inter-channel phase difference change of the current time segment.

The downmixer is a device, which is capable of producing a mono audio signal from a stereo audio signal. The downmixer may comprise or may be a processor. Both audio signals may be digital audio signals.

The term processor refers to an electronic device configured for a specific task. A processor may comprise hardware or a combination of hardware and software. Different processors may share hardware components and/or software components.

The inter-channel phase difference calculator device is a device, which is capable of calculating and outputting an inter-channel phase difference for each time segment of a plurality of time segments of a stereo audio, which is received by the inter-channel phase difference calculator device. The time segment may be a frame of a digital stereo audio signal. The time segments may have a length between 10 ms and 1 s. The inter-channel phase difference calculator device may comprise or may be a processor.

The bitstream producer is a device capable of producing a digital bitstream comprising the mono audio signal received from the downmixer and the related inter-channel phase differences received from the inter-channel phase difference calculator device. The inter-channel bitstream producer may comprise or may be a processor.

The global inter-channel phase difference calculator is a device capable of calculating a global inter-channel phase difference for each time segment of the plurality of consecutive time segments based on a frequency band of the stereo audio signal. The frequency band may be a broadband frequency band having at least a range from 40 Hz to 4 kHz, in particular at least from 20 Hz to 8 kHz. The global inter-channel phase difference calculator may comprise or may be a processor.

The frequency band comprises multiple subbands. The number of subbands may be different depending on the use case. The number of subbands may be, for example, in a range from 4 to 16.

The bandwise inter-channel phase difference calculator is a device capable of calculating a bandwise inter-channel phase difference for each of a plurality of the subbands for each time segment of the plurality of consecutive time segments. The bandwise inter-channel phase difference calculator may comprise or may be a processor.

The bandwise inter-channel phase difference change calculator is a device capable of calculating a bandwise inter-channel phase difference change for each of a plurality of the subbands for each time segment of the plurality of consecutive time segments based on the bandwise inter-channel phase difference of a current time segment of the plurality of consecutive time segments and the bandwise inter-channel phase difference of at least one previous time segment of the plurality of consecutive time segments of the respective subband. The bandwise inter-channel phase difference change calculator may comprise or may be a processor.

The mean bandwise inter-channel phase difference change calculator is a device capable of calculating a mean bandwise inter-channel phase difference change for each time segment of the plurality of consecutive time segments based on the bandwise inter-channel phase difference changes for the respective time segment of each of the plurality the subbands. The mean bandwise inter-channel phase difference change calculator may comprise or may be a processor.

The inter-channel phase difference calculator is a device, which receives the global inter-channel phase difference of the current time segment and the mean bandwise inter-channel phase difference change of the current time segment, and which is capable of calculating the inter-channel phase difference of the current time segment depending on the global inter-channel phase difference of the current time segment and depending on the mean bandwise inter-channel phase difference change of the current time segment. The inter-channel phase difference calculator may comprise or may be a processor.

The invention minimizes unwanted fluctuations in the inter-channel phase differences embedded into the audio bitstream by analyzing the global inter-channel phase differences derived from the larger frequency band and by also analyzing the bandwise inter-channel phase differences derived from the smaller subbands inside the larger frequency band. For each of the subbands a measure of a bandwise inter-channel phase difference change is derived from the current bandwise inter-channel phase difference in the subband of a current time segment and from one or more of the bandwise inter-channel phase differences from previous time segments in the same band.

The individual bandwise inter-channel phase difference changes for the different subbands are then averaged in order to obtain a mean bandwise inter-channel phase difference change, which is a stability measure for the complete frequency band. At the same time, a global inter-channel phase difference estimate for the complete frequency band is calculated. The inter-channel phase difference to be embedded into the audio bitstream for the current time segment is then calculated depending on the global inter-channel phase difference of the current time segment and depending on the mean bandwise inter-channel phase difference change of the current time segment.

If the mean bandwise inter-channel phase difference change is sufficiently small, indicating high stability in the frequency band, strong fluctuations in the inter-channel phase difference estimate will be prevented, e.g. by limiting the maximum change of the inter-channel phase difference from the previous time segment to the current time segment or even by forcing the current inter-channel phase difference to the same value as in the previous time segment. The stabilized inter-channel phase difference is then used at the decoder side for aligning the channels of the reconstructed stereo audio signal all over the given frequency band.

By such features, strong fluctuations of the inter-channel phase difference may be avoided. Moreover, for each time segment only one inter-channel phase difference value needs to be embedded into the audio bitstream.

As a summary, the invention provides an innovative way to use and transmit inter-channel phase differences in an efficient manner while also minimizing unwanted fluctuation effects.

According to some embodiments of the invention, the inter-channel phase difference calculator is configured in such way that the inter-channel phase difference is an element of a closed interval, which is limited by the global inter-channel phase difference of the current time segment and by the inter-channel phase difference of the last previous time segment. A closed interval is an interval, which includes the upper and the lower limit. The use of such an interval reduces fluctuations of the inter-channel phase difference.

According to some embodiments of the invention, the inter-channel phase difference calculator is configured for using the inter-channel phase difference of the last previous time segment as the inter-channel phase difference of the current time segment in case that the mean bandwise inter-channel phase difference change is smaller than a preset value. Such features further reduce fluctuations of the inter-channel phase difference.

According to some embodiments of the invention, the inter-channel phase difference calculator comprises a difference of global inter-channel phase difference calculator configured for calculating for each time segment a modulus of a difference between the inter-channel phase difference of the last previous time segment and the global inter-channel phase difference of the current time segment;
wherein the inter-channel phase difference calculator is configured for using the global inter-channel phase difference of the current time segment as the inter-channel phase difference of the current time segment in case that the mean bandwise inter-channel phase difference change is equal to or greater than the preset value and in case that the modulus of the difference between the inter-channel phase difference of the last previous time segment and the global inter-channel phase difference of the current time segment is equal to or smaller than the mean bandwise inter-channel phase difference change.

The difference of global inter-channel phase difference calculator is a device capable of calculating for each time segment a modulus of a difference between the inter-channel phase difference of the last previous time segment and the global inter-channel phase difference of the current time segment. The difference of global inter-channel phase difference calculator may comprise or may be a processor.

Using the global inter-channel phase difference of the current time segment as the inter-channel phase difference of the current time segment in this specific case further reduce fluctuations of the inter-channel phase difference.

According to some embodiments of the invention, the inter-channel phase difference calculator is configured for using
a sum of the inter-channel phase difference of the last previous time segment and the mean bandwise inter-channel phase difference change, if the global inter-channel phase difference of the current time segment is greater than the inter-channel phase difference of the last previous time segment, or
a difference of the inter-channel phase difference of the last previous time segment and the mean bandwise inter-channel phase difference change, if the global inter-channel phase difference of the current time segment is smaller than the inter-channel phase difference of the last previous time segment,
as the inter-channel phase difference of the current time segment, in case that the mean bandwise inter-channel phase difference change is equal to or greater than the preset value and in case that the modulus of the difference between the inter-channel phase difference of the last previous time segment and the global inter-channel phase difference of the current time segment is greater than the mean bandwise inter-channel phase difference change.

Using the sum or the difference of the inter-channel phase difference of the last previous time segment and the mean bandwise inter-channel phase difference change as the inter-channel phase difference of the current time segment in this specific case further reduce fluctuations of the inter-channel phase difference.

According to some embodiments of the invention, the inter-channel phase difference calculator device comprises a bandwise mean inter-channel phase difference calculator configured for calculating a bandwise mean inter-channel phase difference for each of the subset of the subbands for each time segment of the plurality of consecutive time segments based on a plurality of the previous bandwise inter-channel phase differences of the respective subband;
wherein the bandwise inter-channel phase difference change calculator is configured for calculating the bandwise inter-channel phase difference change for each of the subset of the subbands for each time segment of the plurality of consecutive time segments based on the bandwise inter-channel phase difference of the current time segment and based on bandwise mean inter-channel phase difference of the respective subband.

The bandwise mean inter-channel phase difference calculator is a device capable of calculating a bandwise mean inter-channel phase difference for each of a plurality of the subbands for each time segment of the plurality of consecutive time segments based on a plurality of the previous bandwise inter-channel phase differences of the respective subband. The bandwise mean inter-channel phase difference calculator may comprise or may be a processor.

Calculating the bandwise inter-channel phase difference change as specified here, reduces fluctuations of the inter-channel phase difference further.

According to some embodiments of the invention, the inter-channel phase difference calculator is configured in such way, that the preset value is equal to or larger than 0.2, and that the preset value is equal to or smaller than 0.4. Such features further reduce fluctuations of the inter-channel phase difference.

In a second aspect, the invention provides a method for operating an encoder for producing an audio bitstream from a stereo audio signal, wherein the method comprises the steps of:
using a downmixer of the encoder for downmixing the stereo audio signal in order to produce a mono audio signal;
using an inter-channel phase difference calculator device of the encoder for calculating an inter-channel phase difference for each time segment of a plurality of consecutive time segments of the stereo audio signal;
using a bitstream producer of the encoder to produce the audio bitstream in such way that the mono audio signal and the inter-channel phase differences for the plurality of consecutive time segments are embedded in the audio bitstream;
using a global inter-channel phase difference calculator of the inter-channel phase difference calculator device for calculating a global inter-channel phase difference for each time segment of the plurality of consecutive time segments based on a frequency band of the stereo audio signal, wherein the frequency band comprises a plurality of subbands;
using a bandwise inter-channel phase difference calculator of the inter-channel phase difference calculator device for calculating a bandwise inter-channel phase difference for each of a subset of the subbands for each time segment of the plurality of consecutive time segments;
using a bandwise inter-channel phase difference change calculator of the inter-channel phase difference calculator device for calculating a bandwise inter-channel phase difference change for each of the subset of the subbands for each time segment of the plurality of consecutive time segments based on the bandwise inter-channel phase difference of a current time segment of the plurality of consecutive time segments and the inter-channel phase difference of at least one previous time segment of the plurality of consecutive time segments of the respective subband;
using a mean bandwise inter-channel phase difference change calculator of the inter-channel phase difference calculator device for calculating a mean bandwise inter-channel phase difference change for each time segment of the plurality of consecutive time segments based on the bandwise inter-channel phase difference changes of each of the subset of the subbands;
using an inter-channel phase difference calculator of the inter-channel phase difference calculator device for calculating the inter-channel phase difference depending on the global inter-channel phase difference of the current time segment and depending on the mean bandwise inter-channel phase difference change of the current time segment.

In a third aspect, the invention provides a computer program for, when running on a processor, executing the method according to the invention.

### BRIEF DESCRIPTION OF THE DRAWINGS

Embodiments of the present invention will be detailed subsequently referring to the appended drawings, in which:

FIG. 1 illustrates an embodiment of an encoder for producing an audio bitstream from a stereo audio signal according to the invention in a schematic view;

FIG. 2 illustrates an embodiment of an inter-channel phase difference calculator device configured for calculating an inter-channel phase difference for each time segment of a plurality of consecutive time segments of the stereo audio signal according to the invention in a schematic view;

FIG. 3 shows an exemplary graph of a global inter-channel phase difference over time, which is derived from a frequency band of a stereo audio signal;

FIG. 4 shows exemplary graphs of bandwise inter-channel phase differences over time, of which each is derived from one of the subbands of the frequency band of the audio signal;

FIG. 5 shows an exemplary graph of an inter-channel phase difference over time, wherein the value of the inter-channel phase difference for a current time segment is derived from the global inter-channel phase difference of the current time segment, from the global inter-channel phase difference of a last previous time segment and from the mean bandwise inter-channel phase difference changes of the subsets of the frequency band of the current time segment; and

FIG. 6 illustrates the results of a listening test showing the perceived quality of a play back of the stereo audio signal encoded with a conventional encoder and the perceived quality of a play back of the stereo audio signal encoded with an encoder according to the invention.

### DETAILED DESCRIPTION OF THE INVENTION

Equal or equivalent elements or elements with equal or equivalent functionality are denoted in the following description by equal or equivalent reference numerals.

In the following description, a plurality of details is set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

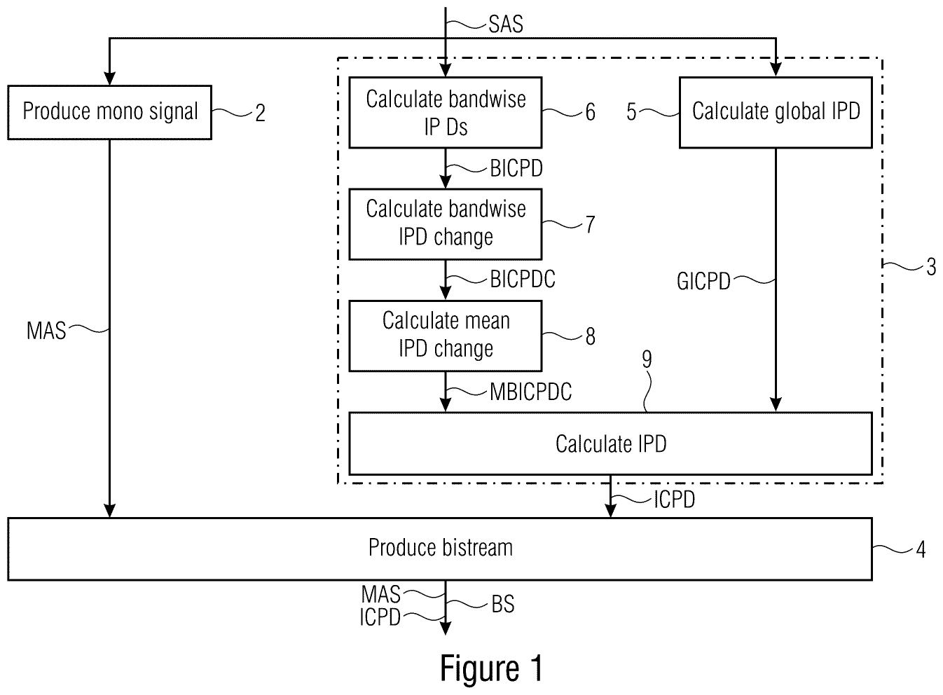

FIG. 1 illustrates an embodiment of an encoder 1 for producing an audio bitstream BS from a stereo audio signal SAS according to the invention in a schematic view. The encoder 1 comprises:
a downmixer 2 configured for downmixing the stereo audio signal SAS in order to produce a mono audio signal MAS;
an inter-channel phase difference calculator device 3 configured for calculating an inter-channel phase difference ICPD for each time segment of a plurality of consecutive time segments of the stereo audio signal SAS; and
a bitstream producer 4 configured to produce the audio bitstream BS in such way that the mono audio signal MAS and the inter-channel phase differences ICPD for the plurality of consecutive time segments are embedded in the audio bitstream;
wherein the inter-channel phase difference calculator device 3 comprises a global inter-channel phase difference calculator 5 configured for calculating a global inter-channel phase difference GICPD for each time segment of the plurality of consecutive time segments based on a frequency band of the stereo audio signal SAS;
wherein the frequency band comprises a plurality of subbands, wherein the inter-channel phase difference calculator device 3 comprises a bandwise inter-channel phase difference calculator 6 configured for calculating a bandwise inter-channel phase difference BICPD for each of a subset of the subbands for each time segment of the plurality of consecutive time segments;
wherein the inter-channel phase difference calculator device 3 comprises a bandwise inter-channel phase difference change calculator 7 configured for calculating a bandwise inter-channel phase difference change BICPDC for each of the subset of the subbands for each time segment of the plurality of consecutive time segments based on the bandwise inter-channel phase difference BICPD of a current time segment of the plurality of consecutive time segments and the bandwise inter-channel phase difference BICPD of at least one previous time segment of the plurality of consecutive time segments of the respective subband;
wherein the inter-channel phase difference calculator device 3 comprises a mean bandwise inter-channel phase difference change calculator 8 configured for calculating a mean bandwise inter-channel phase difference change MBICPDC for each time segment of the plurality of consecutive time segments based on the bandwise inter-channel phase difference changes BICPDC of each of the subset of the subbands;
wherein the inter-channel phase difference calculator device 3 comprises an inter-channel phase difference calculator 9 configured for calculating the inter-channel phase difference ICPD of the current time segment depending on the global inter-channel phase difference GICPD of the current time segment and depending on the mean bandwise inter-channel phase difference change MBICPDC of the current time segment.

According to some embodiments of the invention, the inter-channel phase difference calculator 9 is configured in such way that the inter-channel phase difference ICPD is an element of a closed interval, which is limited by the global inter-channel phase difference GICPD of the current time segment and by the inter-channel phase difference ICPD of the last previous time segment.

In a further aspect, the invention provides a method for operating an encoder 1 for producing an audio bitstream BS from a stereo audio signal SAS, wherein the method comprises the steps of:
using a downmixer 2 of the encoder 1 for downmixing the stereo audio signal SAS in order to produce a mono audio signal MAS;
using an inter-channel phase difference calculator device 3 of the encoder 1 for calculating an inter-channel phase difference ICPD for each time segment of a plurality of consecutive time segments of the stereo audio signal SAS;
using a bitstream producer 4 of the encoder 1 to produce the audio bitstream BS in such way that the mono audio signal MAS and the inter-channel phase differences ICPD for the plurality of consecutive time segments are embedded in the audio bitstream BS;
using a global inter-channel phase difference calculator 5 of the inter-channel phase difference calculator device 3 for calculating a global inter-channel phase difference GICPD for each time segment of the plurality of consecutive time segments based on a frequency band of the stereo audio signal SAS, wherein the frequency band comprises a plurality of subbands;
using a bandwise inter-channel phase difference calculator 6 of the inter-channel phase difference calculator device 3 for calculating a bandwise inter-channel phase difference BICPD for each of a subset of the subbands for each time segment of the plurality of consecutive time segments;
using a bandwise inter-channel phase difference change calculator 7 of the inter-channel phase difference calculator device 3 for calculating a bandwise inter-channel phase difference change BICPDC for each of the subset of the subbands for each time segment of the plurality of consecutive time segments based on the bandwise inter-channel phase difference BICPD of a current time segment of the plurality of consecutive time segments and the bandwise inter-channel phase difference BICPD of at least one previous time segment of the plurality of consecutive time segments of the respective subband;
using a mean bandwise inter-channel phase difference change calculator 8 of the inter-channel phase difference calculator device 3 for calculating a mean bandwise inter-channel phase difference change MBICPDC for each time segment of the plurality of consecutive time segments based on the bandwise inter-channel phase difference changes BICPDC of each of the subset of the subbands;
using an inter-channel phase difference calculator 9 of the inter-channel phase difference calculator device 3 for calculating the inter-channel phase difference ICPD of the current time segment depending on the global inter-channel phase difference GICPD of the current time segment and depending on the mean bandwise inter-channel phase difference change MBICPDC of the current time segment.

In a further aspect, the invention provides a computer program for, when running on a processor, executing the method according to the invention.

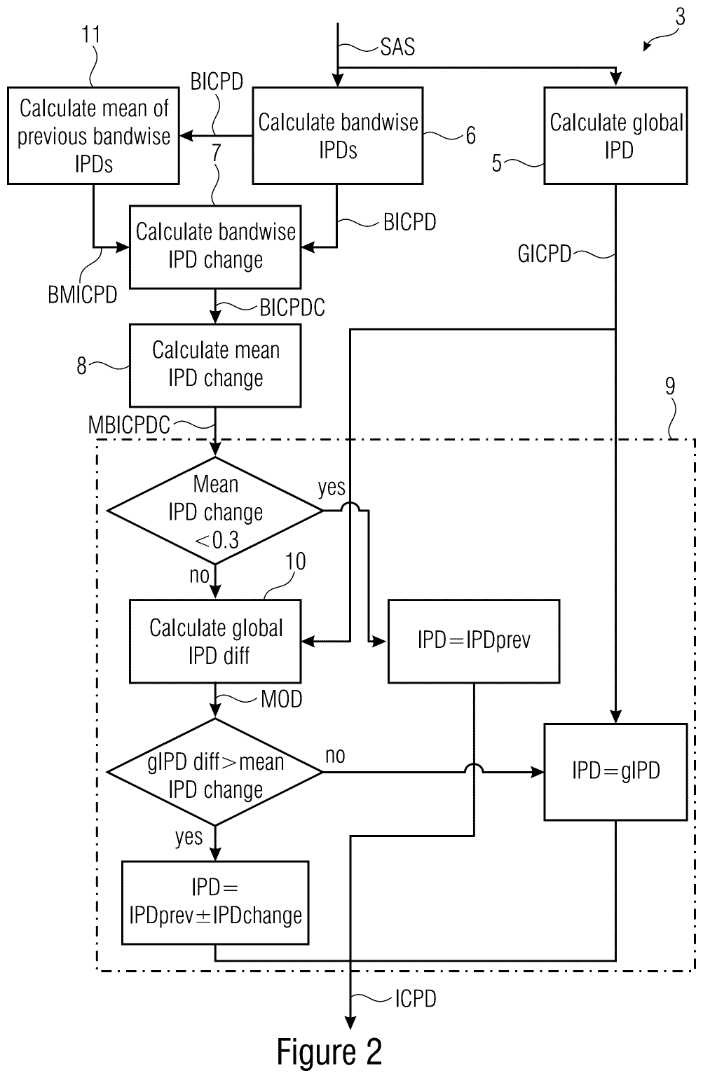

FIG. 2 illustrates an embodiment of an inter-channel phase difference calculator device 3 configured for calculating an inter-channel phase difference ICPD for each time segment of a plurality of consecutive time segments of the stereo audio signal SAS according to the invention in a schematic view.

According to some embodiments of the invention, the inter-channel phase difference calculator 9 is configured for using the inter-channel phase difference ICPD of the last previous time segment as the inter-channel phase difference ICPD of the current time segment in case that the mean bandwise inter-channel phase difference change MICPDC is smaller than a preset value.

According to some embodiments of the invention, the inter-channel phase difference calculator 9 comprises a difference of global inter-channel phase difference calculator 10 configured for calculating for each time segment a modulus MOD of a difference between the inter-channel phase difference ICPD of the last previous time segment and the global inter-channel phase difference GICPD of the current time segment;
wherein the inter-channel phase difference calculator 9 is configured for using the global inter-channel phase difference GICPD of the current time segment as the inter-channel phase difference ICPD of the current time segment in case that the mean bandwise inter-channel phase difference change MICPDC is equal to or greater than the preset value and in case that the modulus MOD of the difference between the inter-channel phase difference ICPD of the last previous time segment and the global inter-channel phase difference GICPD of the current time segment is equal to or smaller than the mean bandwise inter-channel phase difference change MICPDC.

According to some embodiments of the invention, the inter-channel phase difference calculator 9 is configured for using
a sum of the inter-channel phase difference ICPD of the last previous time segment and the mean bandwise inter-channel phase difference change MICPDC, if the global inter-channel phase difference GICPD of the current time segment is greater than the inter-channel phase difference ICPD of the last previous time segment, or
a difference of the inter-channel phase difference ICPD of the last previous time segment and the mean bandwise inter-channel phase difference change MICPDC, if the global inter-channel phase difference GICPD of the current time segment is smaller than the inter-channel phase difference ICPD of the last previous time segment,
as the inter-channel phase difference ICPD of the current time segment, in case that the mean bandwise inter-channel phase difference change MICPDC is equal to or greater than the preset value and in case that the modulus of the difference between the inter-channel phase difference ICPD of the last previous time segment and the global inter-channel phase difference GICPD of the current time segment is greater than the mean bandwise inter-channel phase difference change MICPDC.

According to some embodiments of the invention, wherein the inter-channel phase difference calculator device 3 comprises a bandwise mean inter-channel phase difference calculator 11 configured for calculating a bandwise mean inter-channel phase difference BMICPD for each of the subset of the subbands for each time segment of the plurality of consecutive time segments based on a plurality of the bandwise inter-channel phase differences BICPD of previous of the time segments of the respective subband;
wherein the bandwise inter-channel phase difference change calculator 7 is configured for calculating the bandwise inter-channel phase difference change BICPDC for each of the subset of the subbands for each time segment of the plurality of consecutive time segments based on the bandwise inter-channel phase difference BICPD of the current time segment and based on bandwise mean inter-channel phase difference BMICPD of the respective subband.

According to some embodiments of the invention, the inter-channel phase difference calculator 9 is configured in such way, that the preset value is equal to or larger than 0.2, and that the preset value is equal to or smaller than 0.4.

The invention may be used for different coding schemes. In particular, the invention may be used for the upcoming audio codec IVAS (Immersive Voice and Audio Services) which, amongst other input and output configurations, includes a parametric stereo coder as described in [11]. At the encoder 1, this parametric coder performs a downmixing of the given input stereo audio signal SAS to a single mono audio signal MAS and an extraction of stereo parameters, both of which are transmitted in the bitstream. At the decoder, the mono audio signal MAS is then upmixed back to stereo using the stereo parameters.

For each time segment (frame), these parameters may comprise bandwise information on channel panning via inter-channel loudness differences and decorrelation via inter-channel coherence as well as one single inter-channel time difference and one single inter-channel phase difference ICPD each. In this embodiment, the newly devised method of stabilizing the single inter-channel phase difference ICPD is explained in detail.

The global inter-channel phase difference GICPD may be computed at the global inter-channel phase difference calculator 5 of the encoder 1 over a large frequency band, for example a large range of DFT bins starting with the first complex bin (excluding the DC component) up to certain maximum bin, via the following formula:

$$gIPD = angle ( {\sum }_{i = 1}^{max\_bin} {L}_{i} {R}_{i}^{*} ) = a tan 2 ( y , x )$$

$$with$$

$$y = {\sum }_{i = 1}^{max\_bin} {L}_{i . imag} {R}_{i , real} - {L}_{i , real} {R}_{i , imag}$$

$$and$$

$$x = {\sum }_{i = 1}^{max\_bin} {L}_{i , real} {R}_{i , imag} + {L}_{i , real} {R}_{i , imag} ,$$

wherein gIPD denotes the global inter-channel phase difference GICPD and wherein L denotes the left channel of the stereo audio signal SAS and R denotes the right channel of the stereo audio signal SAS.

In conventional technology, this global inter-channel phase difference GICPD was simply quantized and directly transmitted as the inter-channel phase difference ICPD for the current time frame in the audio bitstream BS without further processing.

For the new stabilization of the inter-channel phase difference ICPD, estimates of bandwise inter-channel phase differences BICPD of subbands inside the frequency band, which are calculated by the bandwise inter-channel phase difference calculator 6, are also taken into account. These may be denoted as IPD_{b} and calculated for each subband b, which may be represented by one of the bins, as

$${IPD}_{b} = angle ( {\sum }_{i = {min\_bin}_{b}}^{{max\_bin}_{b}} {L}_{i} {R}_{i}^{*} ) = a tan 2 ( {y}_{b} , {x}_{b} ) ,$$

$$with$$

$${y}_{b} = {\sum }_{i = {min\_bin}_{b}}^{{max\_bin}_{b}} {L}_{i , imag} {R}_{i , r e a l} - {L}_{i , real} {R}_{i , imag}$$

$$and$$

$${x}_{b} = {\sum }_{i = {min\_bin}_{b}}^{{max\_bin}_{b}} {L}_{i , real} {R}_{i , real} + {L}_{i , imag} {R}_{i , imag} .$$

Additionally, in each subband a bandwise mean inter-channel phase difference BMICPD over previous time segments (for example five time segments in the implementation of the embodiment) may be calculated by the bandwise mean inter-channel phase difference calculator 11. Since distances between phases are ambiguous (2 possible directions on a circle) a meaningful bandwise mean inter-channel phase difference BMICPD cannot always be calculated by standard averaging (only if all phases are within the same semi-circle). Instead, the bandwise mean inter-channel phase difference BMICPD of a subband, denoted as IPD_{mean,b}, may be initialized with 0 and then updated iteratively with

$${IPD}_{m ean , b} = \frac{i}{i + 1} {IPD}_{m e a n , b} + \frac{1}{i + 1} {IPD}_{p r e v , b} [ i ] .$$

where i=0, . . . , 4 is the index over the previous inter-channel phase difference values of the band. After each iteration, the distance IPD_{diff} of the current result to the next value in the IPD_{b_prev} buffer is calculated:

$${IPD}_{diff} = \vert {IPD}_{m ean , b} - {IPD}_{prev , b} [ i + 1 ] \vert .$$

If IPD_{diff} is greater than π, i.e. more than a half-circle rotation in the given direction, IPD_{mean,b} needs to be temporarily shifted outside of the [−π,π] range by adding or subtracting 2π depending on which side of the circle it lies on:

$${IPD}_{m e a n , b} = {IPD}_{m ean , b} + 2 π , \qquad if {IPD}_{m e a n , b} < 0$$

$$or$$

$${IPD}_{m e a n , b} = {IPD}_{m e a n , b} - 2 π , \qquad if {IPD}_{m e a n , b} > 0 .$$

Then the bandwise mean inter-channel phase difference BMICPD will be updated using this shifted version which now has a distance of less than π to the next value in IPD_{prev,b}. If after the update IPD_{mean,b} is still outside [−π,π] the shift is reversed before the next iteration.

Now the bandwise inter-channel phase difference change BICPDC, denoted as IPD_{change,b}, between the current bandwise inter-channel phase differences BICPD (IPD_{b}) and the bandwise mean inter-channel phase difference BMICPD (IPD_{mean,b}) is computed by the bandwise inter-channel phase difference change calculator 7 for each subband with

$${IPD}_{c h a n g e , b} = \vert {IPD}_{b} - {IPD}_{m e a n , b} \vert$$

$$with$$

$${IPD}_{c h a n g e , b} = 2 π - {IPD}_{c h a nge , b} , \qquad if {IPD}_{c h a nge , b} > π .$$

From the individual bandwise inter-channel phase difference change BICPDC in each subband a mean bandwise inter-channel phase difference change MBICPD, denoted as IPD_{change}) over all subbands is computed by a mean bandwise inter-channel phase difference change calculator 8:

$${IPD}_{c h a n g e} = \frac{{\sum }_{b = 1}^{n B a n d s} {IPD}_{c hange , b}}{n B a n d s} .$$

This mean bandwise inter-channel phase difference change MBICPD is taken as an overall indication of the stability of the bandwise inter-channel phase difference BICPD in the current time segment and is now used to force a similar level of stability on the inter-channel phase difference ICPD.

For very small values of the mean bandwise inter-channel phase difference change MBICPD (smaller than 0.3 in the implementation of the embodiment) the inter-channel phase difference ICPD of the last previous time segment is used as the inter-channel phase difference ICPD and embedded into the audio bitstream BS for the current time segment:

IPD=IPDₚᵣₑᵥ,if IPD_{change}<0.3,
wherein IPD is the inter-channel phase difference ICPD for the current time segment and IPDₚᵣₑᵥ is the inter-channel phase difference ICPD for the current time segment is the inter-channel phase difference ICPD for the last previous time segment.

For larger values of the mean bandwise inter-channel phase difference change MBICPD a modulus MOD of a difference between the inter-channel phase difference ICPD of the last previous time segment and the global inter-channel phase difference GICPD of the current time segment, which is denoted as gIPD_{diff}, may be computed by the difference of global inter-channel phase difference calculator 10:

$${gIPD}_{diff} = \vert gIPD - {IPD}_{p r e v} \vert$$

$$with$$

$${gIPD}_{diff} = 2 π - {gIPD}_{diff} , \qquad if {gIPD}_{diff} > π .$$

If

gIPD_{diff}>IPD_{change},
which means that the modulus MOD of the difference between the inter-channel phase difference ICPD of the last previous time segment and the global inter-channel phase difference GICPD of the current time segment is larger than the mean bandwise inter-channel phase difference change MBICPD, the maximum allowed change of the inter-channel phase difference ICPD of the last previous time segment is limited to the mean bandwise inter-channel phase difference change MBICPD, so that the inter-channel phase difference ICPD is calculated as:

$$IPD = {IPD}_{p r e v} + {IPD}_{c h a n g e} , \qquad if gIPD > {IPD}_{p r e v}$$

$$or$$

$$IPD = {gIPD}_{p r e v} - {IPD}_{c h a n g e} , \qquad if gIPD < {IPD}_{p r e v} .$$

If, however,

gIPD_{diff}≤IPD_{change};
which means that the modulus MOD of the difference between the inter-channel phase difference ICPD of the last previous time segment and the global inter-channel phase difference GICPD of the current time segment is equal to or smaller than the mean bandwise inter-channel phase difference change MBICPD, the global inter-channel phase difference GICPD of the current time segment is used as the inter-channel phase difference ICPD for the current time frame, so that the inter-channel phase difference ICPD may be calculated as:

IPD=gIPD

The inter-channel phase difference ICPD stabilized as described above, can now be quantized and transmitted as a side parameter in the audio bitstream BS.

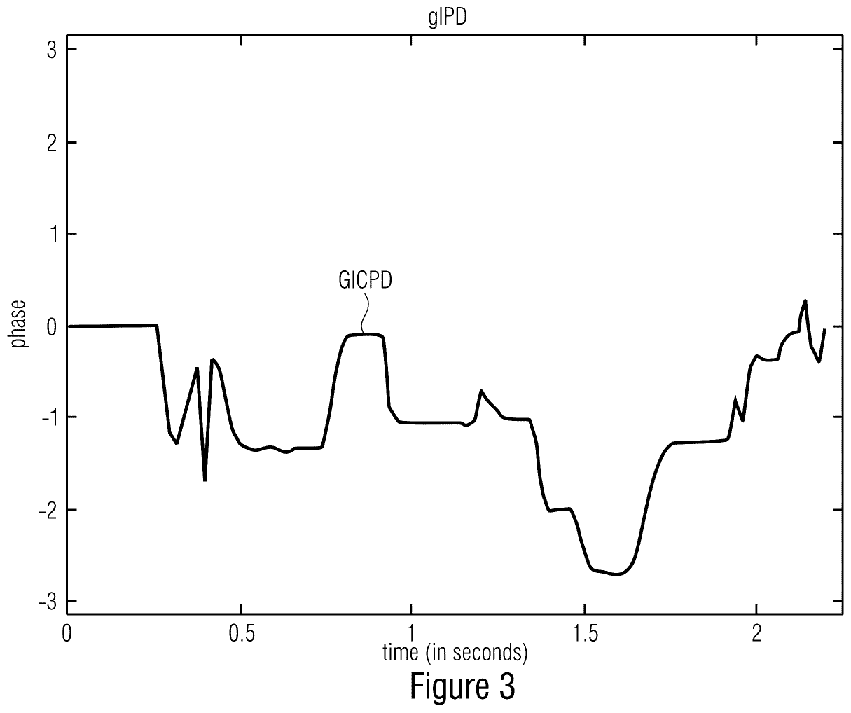

FIG. 3 shows an exemplary graph of a global inter-channel phase difference GICPD over time, which is derived from a full or at least broad frequency band of a stereo audio signal SAS. The graph shows the value of a global inter-channel phase difference GICPD which is estimated over a large frequency band. It is obvious that this global inter-channel phase difference GICPD is anything but stable but fluctuates wildly between 0.3 and −π. Thus, simply using this global inter-channel phase difference GICPD as the inter-channel phase difference ICPD to be embedded into the audio bitstream BS would—without further processing—would result in a low quality of a playback of the reconstructed stereo audio signal at the decoder side.

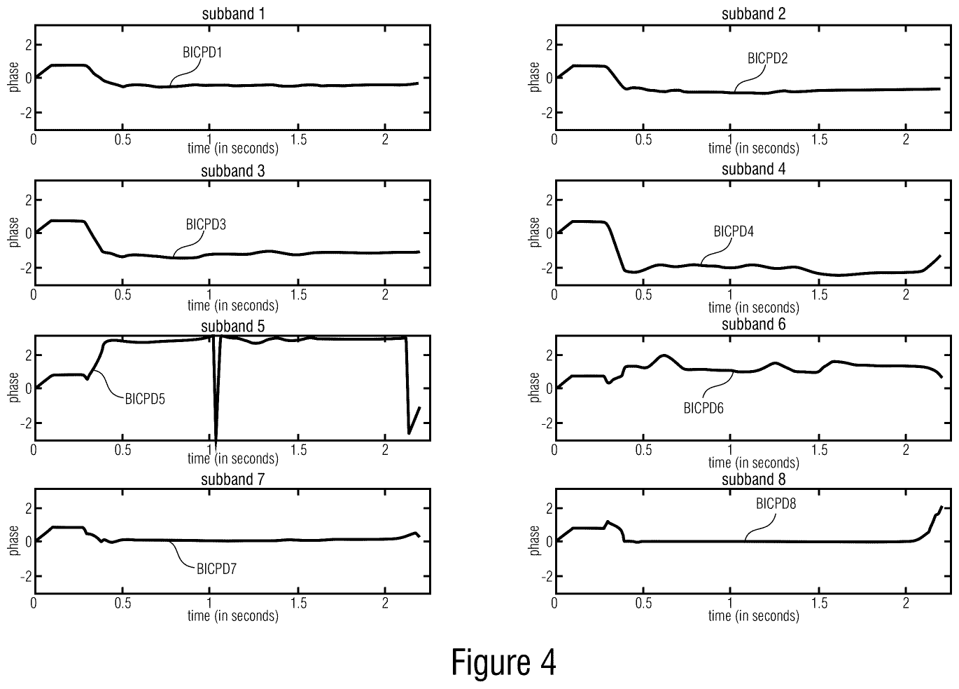

FIG. 4 shows exemplary graphs of bandwise inter-channel phase differences BICPD over time, of which each is derived from one of the eight subbands of the larger frequency band of the audio signal SAS, which is shown in FIG. 3. Here it can be seen that the bandwise inter-channel phase differences BICPD vary between the subbands but are in general much more stable over time than the global inter-channel phase difference GICPD of the complete frequency band.

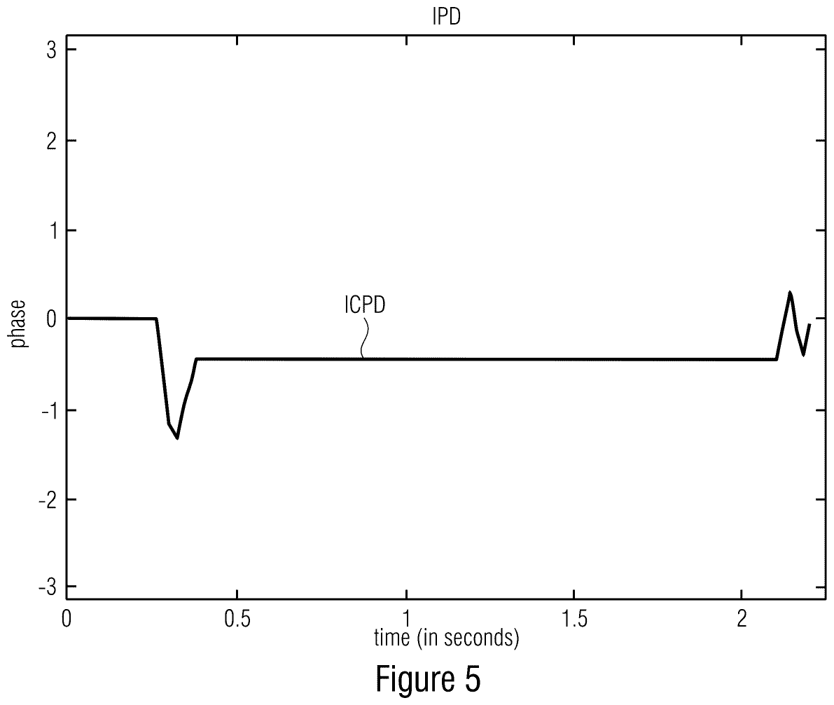

FIG. 5 shows an exemplary graph of an inter-channel phase difference ICPD over time, wherein the value of the inter-channel phase difference ICPD for a current time segment is derived from the global inter-channel phase difference GICPD of the current time segment and from the mean bandwise inter-channel phase difference changes MBICPDC of the subsets of the frequency band of the current time segment. Due to the stability of the bandwise inter-channel phase differences BICPD the inter-channel phase difference ICPD is now also forced to remain stable compared to the global inter-channel phase difference GICPD shown in FIG. 3.

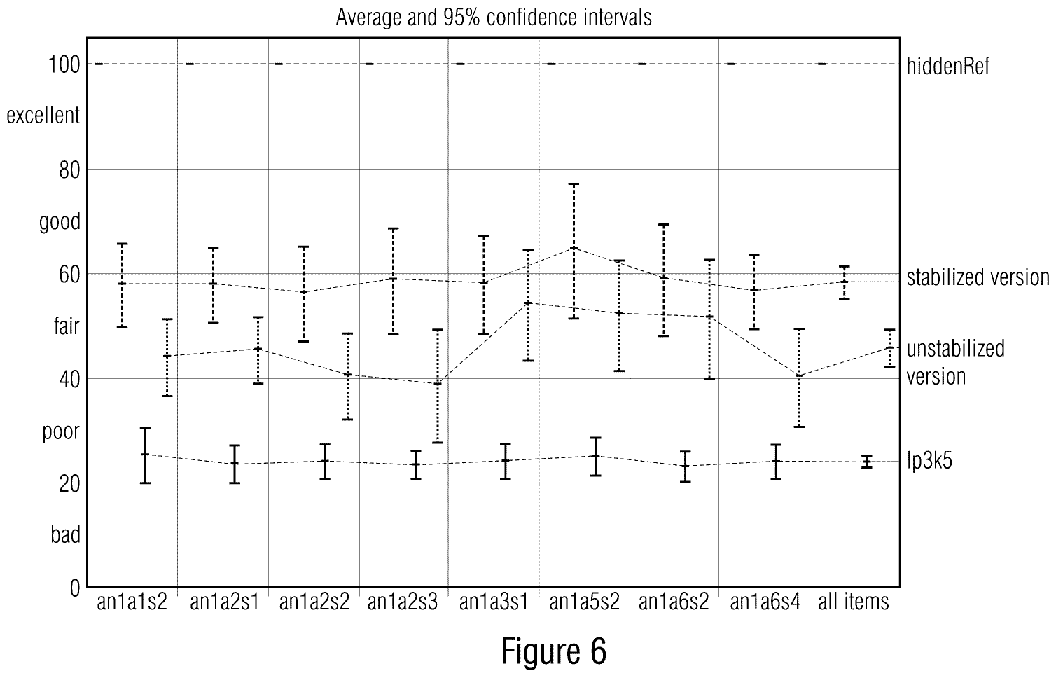

FIG. 6 illustrates the results of a listening test showing the perceived quality of a play back of the stereo audio signal encoded with a conventional encoder and the perceived quality of a play back of the stereo audio signal encoded with an encoder according to the invention.

The listening test has been done as a MUSHRA listening test with binauralized clean speech input coded with the IVAS stereo coder at 24.4 kbps. MUSHRA stands for Multiple Stimuli with Hidden Reference and Anchor and is a methodology for conducting a codec listening test to evaluate the perceived quality of the output from lossy audio compression algorithms. It is defined by ITU-R recommendation BS.1534-3.

Seven expert listeners have assessed the quality of an audio playback from an audio bitstream, which has been encoded using a unstabilized broadband inter-channel phase difference according to conventional technology, and the quality of an audio playback from an audio bitstream, which has been encoded using the stabilized inter-channel phase difference according to the invention.

The results make it clear that there is an obvious improvement of the stabilized version over the version without any inter-channel phase difference stabilization.

Depending on certain implementation requirements, embodiments of the inventive device and system can be implemented in hardware and/or in software. The implementation can be performed using a digital storage medium, for example a floppy disk, a DVD, a Blu-ray Disc, a CD, a ROM, a PROM, an EPROM, an EEPROM or a FLASH memory, having electronically readable control signals stored thereon, which cooperate (or are capable of cooperating) with a programmable computer system such that one or more or all of the functionalities of the inventive device or system is performed.

In some embodiments, a programmable logic device (for example a field programmable gate array) may be used to perform one or more or all of the functionalities of the devices and systems described herein. In some embodiments, a field programmable gate array may cooperate with a microprocessor in order to perform one or more or all of the functionalities of the devices and systems described herein.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the inventive method can be implemented using an apparatus comprising hardware and/or software. The implementation can be performed using a digital storage medium, for example a floppy disk, a DVD, a Blu-ray Disc, a CD, a ROM, a PROM, an EPROM, an EEPROM or a FLASH memory, having electronically readable control signals stored thereon, which cooperate (or are capable of cooperating) with a programmable computer system such that the respective method is performed.

Depending on certain implementation requirements, embodiments of the inventive method can be implemented using an apparatus comprising hardware and/or software.

Some or all of the method steps may be executed by (or using) a hardware apparatus, like a microprocessor, a programmable computer or an electronic circuit. Some one or more of the most important method steps may be executed by such an apparatus.

Some embodiments according to the invention comprise a data carrier having electronically readable control signals, which are capable of cooperating with a programmable computer system such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, which is stored on a machine readable carrier or a non-transitory storage medium.

A further embodiment comprises a processing mean, for example a computer, or a programmable logic device, in particular a processor comprising hardware, configured or adapted to perform one of the methods described herein.

A further embodiment comprises a computer having installed thereon the computer program for performing one of the methods described herein.

Generally, the methods are advantageously performed by any apparatus comprising hardware and or software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] F. Baumgarte and C. Faller, “Binaural Cue Coding-Part I: Psycho-acoustic fundamentals and design principles,” IEEE Trans. on Speech and Audio Proc., vol. 11, no. 6, pp. pp. 509-519, 2003.
[2] F. Baumgarte and C. Faller, “Binaural Cue Coding-Part II: Schemes and applications,” IEEE Trans. on Speech and Audio Proc., vol. 11, no. 6, pp. pp. 520-531, 2003.
[3] E. Schuijers, W. Oomen, B. Brinker and J. Breebaart, “Advances in Parametric Coding for High-Quality Audio,” in Preprint 5852, 114th AES convention, Amsterdam, 2003.
[4] J. Breebaart, S. v. d. Par, A. Kohlrausch and E. Schuijers, “Parametric Coding of Stereo Audio,” EURASIP Journal on Applied Signal Processing, pp. 1305-1322 September 2005.
[5] J. Blauert, Spatial Hearing: The Psychoacoustics of Human Sound Localization, Cambridge, USA: MIT Press, 1997.
[6] T. Hoang, S. Ragot, B. Kovesi and P. Scalart, “Parametric stereo extension of ITU-T G.722 based on a new downmixing scheme,” in Proc. IEEE MMSP, St Malo, France, 2010.
[7] C. Tournery and C. Faller, “Improved time delay analysis/synthesis for parametric stereo audio coding,” in Preprint 120th Conv. Aud. Eng. Soc., 2006.
[8] W. Wu, L. Miao, Y. Lang and D. Virette, “Parametric stereo coding scheme with a new downmix method and whole band inter channel time/phase differences,” in IEEE International Conference on Acoustics, Speech and Signal Processing, Vancouver, BC, Canada, 2013.
[9] M. Neusinger, J. Hilpert, B. Grill, J. Robilliard and M. Luis Valero, “Efficient Use Of Phase Information In Audio Encoding And Decoding”. WO Patent WO10003575, 30 Jun. 2009.
[10] S. Bayer, E. Fotopoulou, M. Multrus, G. Fuchs, E. Ravelli, M. Schnell, S. Dohla, W. Jaegers, M. Dietz and G. Markovic, “Apparatus and method for encoding or decoding a multi-channel signal using a broadband alignment parameter and a plurality of narrowband alignment parameters”. WO Patent WO2017125558A1, 27 Jul. 2017.
[11] S. Bayer, M. Dietz, S. Döhla, E. Fotopoulou, G. Fuchs, W. Jaegers, G. Markovic, M. Multrus, E. Ravelli and M. Schnell, “APPARATUS AND METHOD FOR ESTIMATING AN INTER-CHANNEL TIME DIFFERENCE”. Patent WO17125563, 27 Jul. 2017.

1. An encoder for producing an audio bitstream from a stereo audio signal, wherein the encoder comprises:
a downmixer configured for downmixing the stereo audio signal in order to produce a mono audio signal;
an inter-channel phase difference calculator device configured for calculating an inter-channel phase difference for each time segment of a plurality of consecutive time segments of the stereo audio signal; and
a bitstream producer configured to produce the audio bitstream in such way that the mono audio signal and the inter-channel phase differences for the plurality of consecutive time segments are embedded in the audio bitstream;
wherein the inter-channel phase difference calculator device comprises a global inter-channel phase difference calculator configured for calculating a global inter-channel phase difference for each time segment of the plurality of consecutive time segments based on a frequency band of the stereo audio signal;
wherein the frequency band comprises a plurality of subbands, wherein the inter-channel phase difference calculator device comprises a bandwise inter-channel phase difference calculator configured for calculating a bandwise inter-channel phase difference for each of a subset of the subbands for each time segment of the plurality of consecutive time segments;
wherein the inter-channel phase difference calculator device comprises a bandwise inter-channel phase difference change calculator configured for calculating a bandwise inter-channel phase difference change for each of the subset of the subbands for each time segment of the plurality of consecutive time segments based on the bandwise inter-channel phase difference of a current time segment of the plurality of consecutive time segments and the bandwise inter-channel phase difference of at least one previous time segment of the plurality of consecutive time segments of the respective subband;
wherein the inter-channel phase difference calculator device comprises a mean bandwise inter-channel phase difference change calculator configured for calculating a mean bandwise inter-channel phase difference change for each time segment of the plurality of consecutive time segments based on the bandwise inter-channel phase difference changes of each of the subset of the subbands;
wherein the inter-channel phase difference calculator device comprises an inter-channel phase difference calculator configured for calculating the inter-channel phase difference of the current time segment depending on the global inter-channel phase difference of the current time segment and depending on the mean bandwise inter-channel phase difference change of the current time segment.

2. The encoder according to claim 1, wherein the inter-channel phase difference calculator is configured in such way that the inter-channel phase difference is an element of a closed interval, which is limited by the global inter-channel phase difference of the current time segment and by the inter-channel phase difference of the last previous time segment.

3. The encoder according to claim 1, wherein the inter-channel phase difference calculator is configured for using the inter-channel phase difference of the last previous time segment as the inter-channel phase difference of the current time segment in case that the mean bandwise inter-channel phase difference change is smaller than a preset value.

4. The encoder according to claim 3, wherein the inter-channel phase difference calculator comprises a difference of global inter-channel phase difference calculator configured for calculating for each time segment a modulus of a difference between the inter-channel phase difference of the last previous time segment and the global inter-channel phase difference of the current time segment;
wherein the inter-channel phase difference calculator is configured for using the global inter-channel phase difference of the current time segment as the inter-channel phase difference of the current time segment in case that the mean bandwise inter-channel phase difference change is equal to or greater than the preset value and in case that the modulus of the difference between the inter-channel phase difference of the last previous time segment and the global inter-channel phase difference of the current time segment is equal to or smaller than the mean bandwise inter-channel phase difference change.

5. The encoder according to the claim 4, wherein the inter-channel phase difference calculator is configured for using
a sum of the inter-channel phase difference of the last previous time segment and the mean bandwise inter-channel phase difference change, if the global inter-channel phase difference of the current time segment is greater than the inter-channel phase difference of the last previous time segment, or
a difference of the inter-channel phase difference of the last previous time segment and the mean bandwise inter-channel phase difference change, if the global inter-channel phase difference of the current time segment is smaller than the inter-channel phase difference of the last previous time segment,
as the inter-channel phase difference of the current time segment, in case that the mean bandwise inter-channel phase difference change is equal to or greater than the preset value and in case that the modulus of the difference between the inter-channel phase difference of the last previous time segment and the global inter-channel phase difference of the current time segment is greater than the mean bandwise inter-channel phase difference change.

6. The encoder according to claim 1, wherein the inter-channel phase difference calculator device comprises a bandwise mean inter-channel phase difference calculator configured for calculating a bandwise mean inter-channel phase difference for each of the subset of the subbands for each time segment of the plurality of consecutive time segments based on a plurality of the bandwise inter-channel phase differences of previous of the time segments of the respective subband;
wherein the bandwise inter-channel phase difference change calculator is configured for calculating the bandwise inter-channel phase difference change for each of the subset of the subbands for each time segment of the plurality of consecutive time segments based on the bandwise inter-channel phase difference of the current time segment and based on bandwise mean inter-channel phase difference of the respective subband.

7. The encoder according to claim 3, wherein the inter-channel phase difference calculator is configured in such way, that the preset value is equal to or larger than 0.2, and that the preset value is equal to or smaller than 0.4.

8. A method for operating an encoder for producing an audio bitstream from a stereo audio signal, wherein the method comprises:
using a downmixer of the encoder for downmixing the stereo audio signal in order to produce a mono audio signal;
using an inter-channel phase difference calculator device of the encoder for calculating an inter-channel phase difference for each time segment of a plurality of consecutive time segments of the stereo audio signal;
using a bitstream producer of the encoder to produce the audio bitstream in such way that the mono audio signal and the inter-channel phase differences for the plurality of consecutive time segments are embedded in the audio bitstream;
using a global inter-channel phase difference calculator of the inter-channel phase difference calculator device for calculating a global inter-channel phase difference for each time segment of the plurality of consecutive time segments based on a frequency band of the stereo audio signal, wherein the frequency band comprises a plurality of subbands;
using a bandwise inter-channel phase difference calculator of the inter-channel phase difference calculator device for calculating a bandwise inter-channel phase difference for each of a subset of the subbands for each time segment of the plurality of consecutive time segments;
using a bandwise inter-channel phase difference change calculator of the inter-channel phase difference calculator device for calculating a bandwise inter-channel phase difference change for each of the subset of the subbands for each time segment of the plurality of consecutive time segments based on the bandwise inter-channel phase difference of a current time segment of the plurality of consecutive time segments and the bandwise inter-channel phase difference of at least one previous time segment of the plurality of consecutive time segments of the respective subband;
using a mean bandwise inter-channel phase difference change calculator of the inter-channel phase difference calculator device for calculating a mean bandwise inter-channel phase difference change for each time segment of the plurality of consecutive time segments based on the bandwise inter-channel phase difference changes of each of the subset of the subbands;
using an inter-channel phase difference calculator of the inter-channel phase difference calculator device for calculating the inter-channel phase difference of the current time segment depending on the global inter-channel phase difference of the current time segment and depending on the mean bandwise inter-channel phase difference change of the current time segment.

9. A non-transitory digital storage medium having a computer program stored thereon to perform the method method for operating an encoder for producing an audio bitstream from a stereo audio signal, wherein the method comprises:
using a downmixer of the encoder for downmixing the stereo audio signal in order to produce a mono audio signal;
using an inter-channel phase difference calculator device of the encoder for calculating an inter-channel phase difference for each time segment of a plurality of consecutive time segments of the stereo audio signal;
using a bitstream producer of the encoder to produce the audio bitstream in such way that the mono audio signal and the inter-channel phase differences for the plurality of consecutive time segments are embedded in the audio bitstream;
using a global inter-channel phase difference calculator of the inter-channel phase difference calculator device for calculating a global inter-channel phase difference for each time segment of the plurality of consecutive time segments based on a frequency band of the stereo audio signal, wherein the frequency band comprises a plurality of subbands;
using a bandwise inter-channel phase difference calculator of the inter-channel phase difference calculator device for calculating a bandwise inter-channel phase difference for each of a subset of the subbands for each time segment of the plurality of consecutive time segments;
using a bandwise inter-channel phase difference change calculator of the inter-channel phase difference calculator device for calculating a bandwise inter-channel phase difference change for each of the subset of the subbands for each time segment of the plurality of consecutive time segments based on the bandwise inter-channel phase difference of a current time segment of the plurality of consecutive time segments and the bandwise inter-channel phase difference of at least one previous time segment of the plurality of consecutive time segments of the respective subband;
using a mean bandwise inter-channel phase difference change calculator of the inter-channel phase difference calculator device for calculating a mean bandwise inter-channel phase difference change for each time segment of the plurality of consecutive time segments based on the bandwise inter-channel phase difference changes of each of the subset of the subbands;
using an inter-channel phase difference calculator of the inter-channel phase difference calculator device for calculating the inter-channel phase difference of the current time segment depending on the global inter-channel phase difference of the current time segment and depending on the mean bandwise inter-channel phase difference change of the current time segment,
when said computer program is run by a computer.
